(19) United States
(12) Patent Application Publication
(10) Pub. No.: US 2010/0100942 A1
(43) Pub. Date: Apr. 22, 2010

(54) System and Method for Exchanging Information Regarding Financial Markets in a Moderated Environment

(75) Inventors: Kevin Wassong, New York, NY (US); Todd Harrison, New York, NY (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Minyanville Publishing and Multimedia, LLC

(21) Appl. No.: 12/604,311

(22) Filed: Oct. 22, 2009

Related U.S. Application Data
(60) Provisional application No. 61/107,586, filed on Oct. 22, 2008.
(60) Provisional application No. 61/107,583, filed on Oct. 22, 2008.

(51) Int. Cl. G06F 21/00; G06Q 99/00; G06Q 40/00

(52) U.S. Cl. 726/4; 705/319

(57) ABSTRACT

A method and system for exchanging information regarding financial markets in a moderated environment are disclosed. According to one embodiment, a computer-implemented method comprises granting an administrator access to a collaborative interface, wherein the collaborative interface is one for a financial group that accepts posts from registered group members and distributes posts to the registered group members upon submission of new posts, and wherein the administrator approves the distribution of each new post. One or more clients are granted access to the collaborative interface, wherein the administrator identifies a permission level for each client. Posts are received from the administrator or a client of the one or more additional clients, approval is received from the administrator to display the post, and the post is displayed.

The present application claims the benefit of and priority to U.S. Provisional Patent Application No. 61/107,583 entitled “A System and Method for Exchanging Information Regarding Financial Markets in a Moderated Environment” filed on Oct. 22, 2008, and is hereby, incorporated by reference.

### FIELD

The present system relates in general to computer applications and, more specifically, to a system and method for exchanging information regarding financial markets in a moderated environment.

### BACKGROUND

Financial market information is available through publications and online news sources. Analysis of financial market information is typically provided in summary form at the end of a specified trading period. These summaries do not provide real-time analysis to allow users to act upon the information, nor do they provide a user with the ability to interact with the poster of the information in real-time.

Message boards are an electronic version of a bulletin board, and they provide users the ability to receive real-time updated information related to any topic the user is interested in. Users can participate in a message board anonymously or users can register to be a member of a particular online forum.

In existing forums, a user may simultaneously register under different pseudonyms on a particular message board or forum. A user communicating financial market information under multiple accounts can pose a significant problem if other forum members choose to rely upon the information for decision making. Users simultaneously registered under different accounts are usually found when an IP check is done on the accounts in a forum.

Users sometimes post versions of a message that are only slightly different, especially in forums where they are not allowed to edit their earlier posts. Multiple posting instead of editing prior posts can artificially inflate a user's post count. Multiple posting can be unintentional; a user's browser might display an error message even though the post has been transmitted or a user of a slow forum might become impatient and repeatedly hit the submit button.

### SUMMARY

A method and system for exchanging information regarding financial markets in a moderated environment are disclosed. According to one embodiment, a computer-implemented method comprises granting an administrator access to a collaborative interface, wherein the collaborative interface is one for a financial group that accepts posts from registered group members and distributes posts to the registered group members upon submission of new posts, and wherein the administrator approves the distribution of each new post. One or more clients are granted access to the collaborative interface, wherein the administrator identifies a permission level for each client. Posts are received from the administrator or a client of the one or more additional clients, approval is received from the administrator to display the post, and the post is displayed.

### BRIEF DESCRIPTION

The accompanying drawings, which are included as part of the present specification, illustrate the presently preferred embodiment and together with the general description given above and the detailed description of the preferred embodiment given below serve to explain and teach the principles of the present invention.

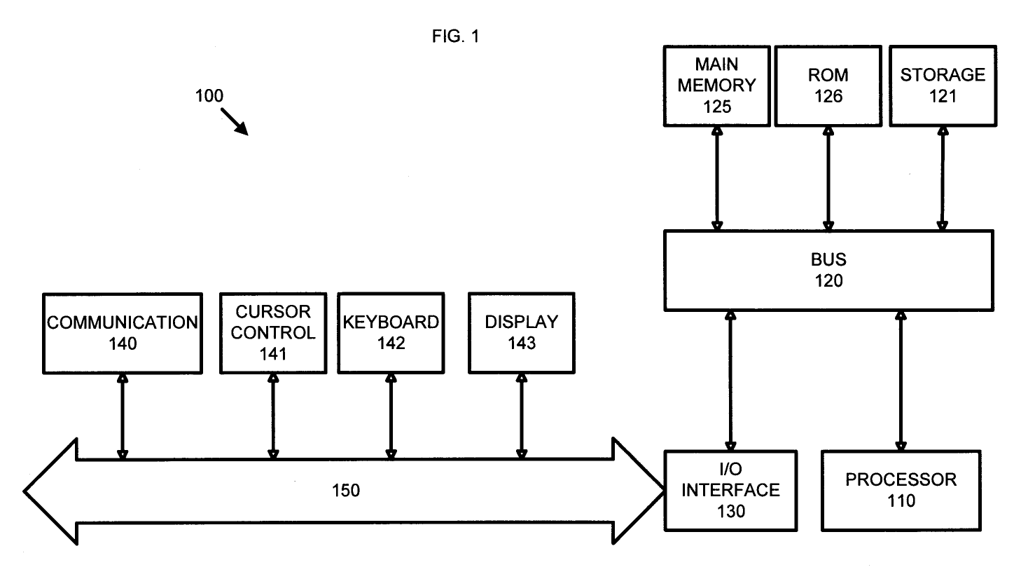

FIG. 1 illustrates an exemplary computer architecture for use with the present system, according to one embodiment.

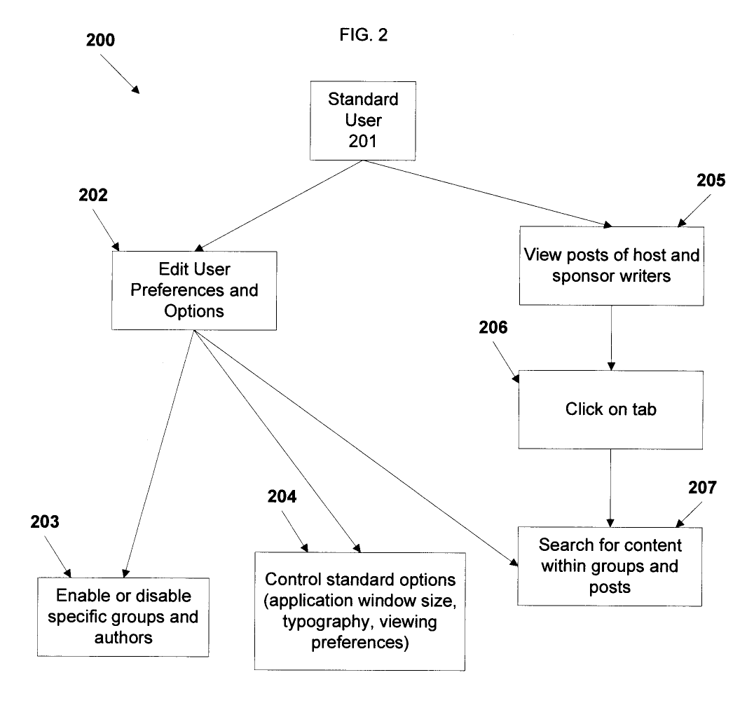

FIG. 2 illustrates exemplary actions available to a standard user as a reader within the present system, according to one embodiment.

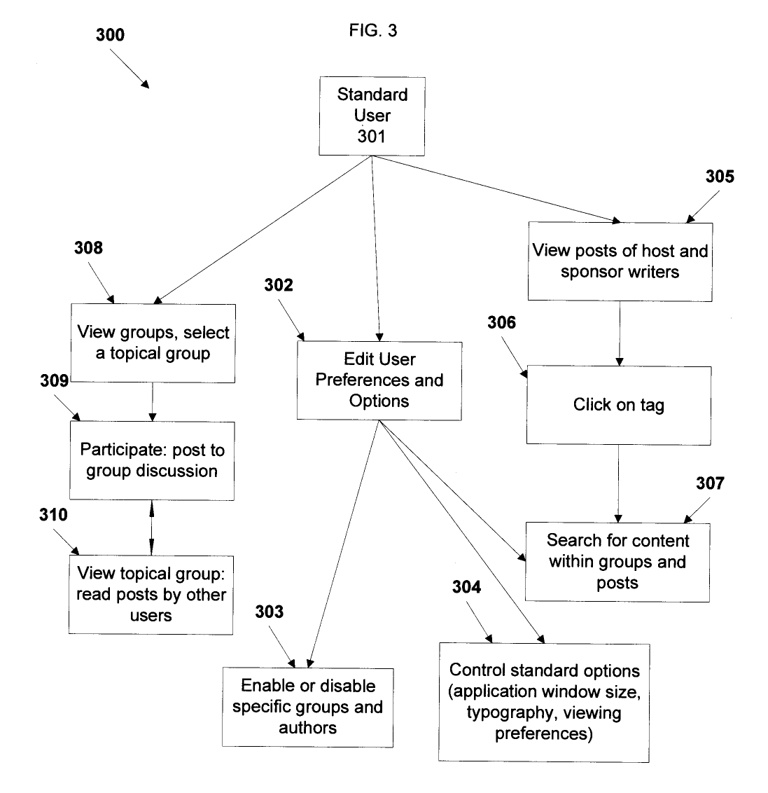

FIG. 3 illustrates exemplary actions available to a standard user as a discussion participant within the present system, according to one embodiment.

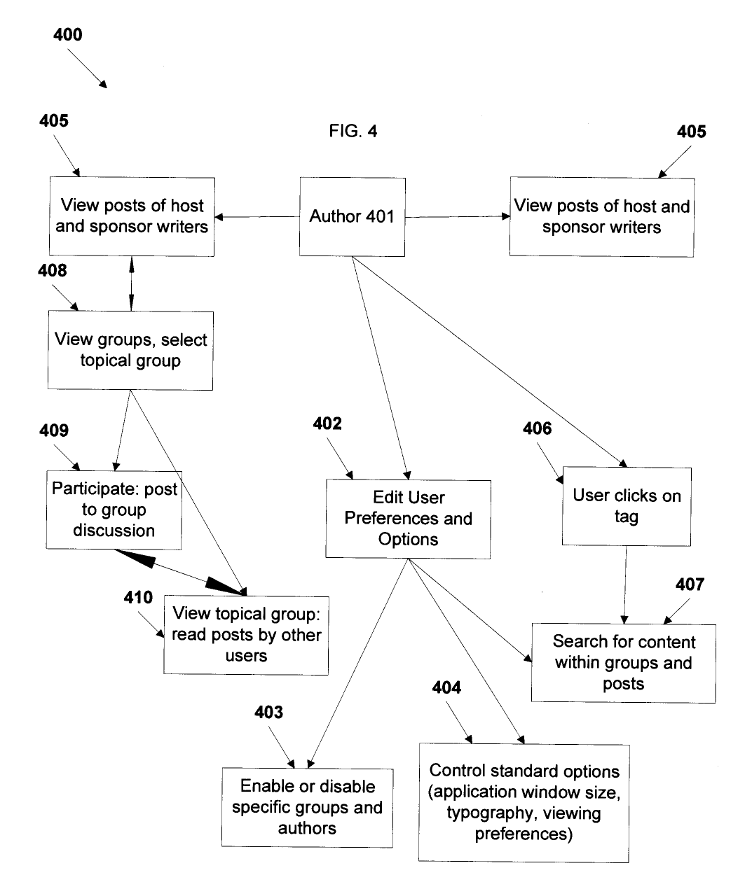

FIG. 4 illustrates exemplary actions available to a user as an author within the present system, according to one embodiment.

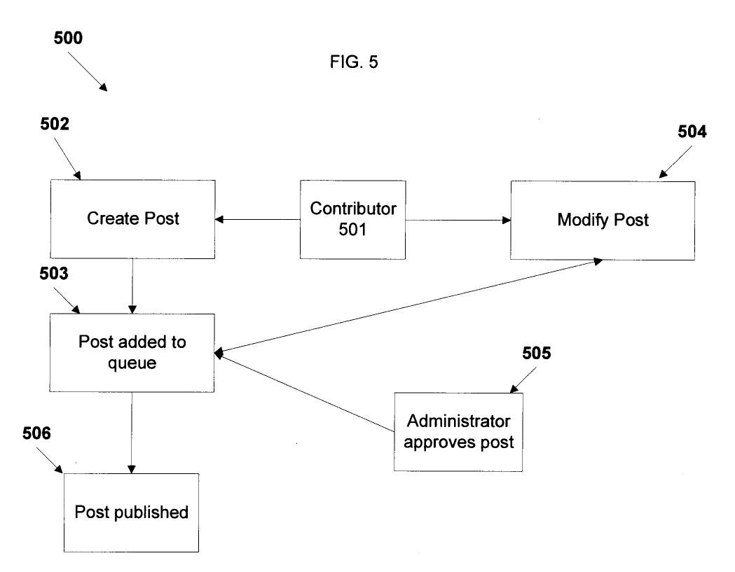

FIG. 5 illustrates exemplary actions available to a contributor within the present system, according to one embodiment.

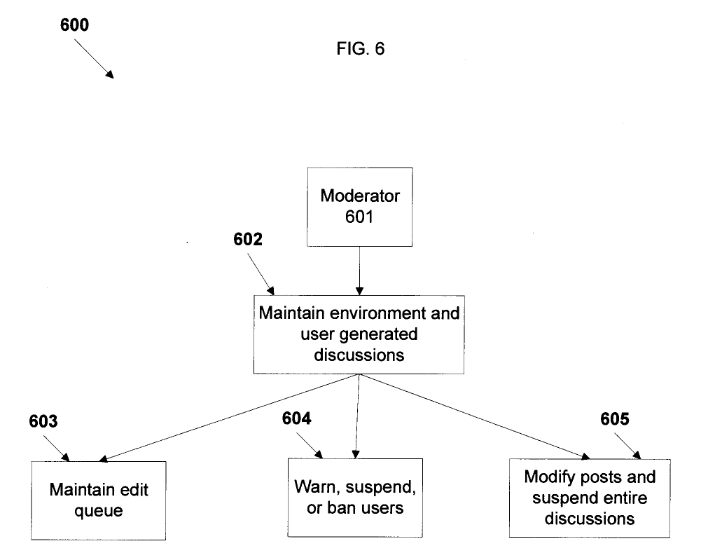

FIG. 6 illustrates exemplary actions available to a moderator within the present system, according to one embodiment.

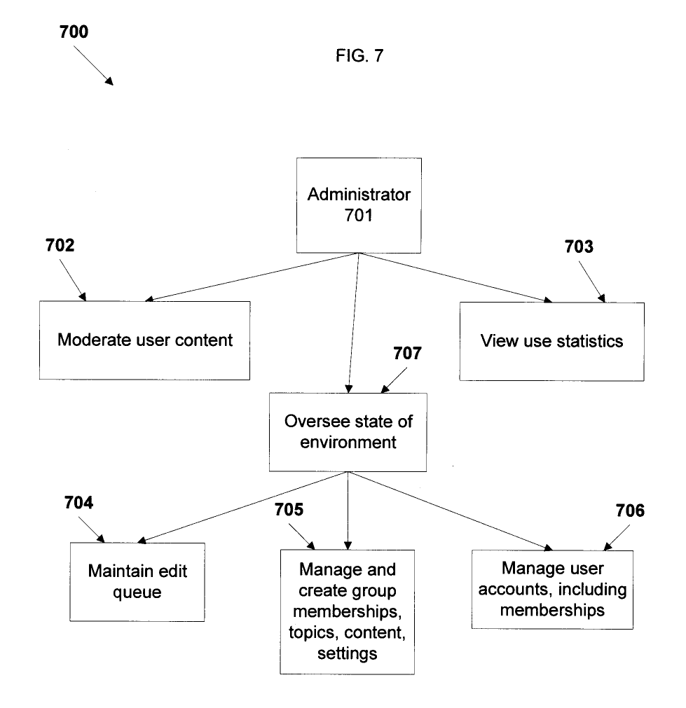

FIG. 7 illustrates exemplary actions available to an administrator within the present system, according to one embodiment.

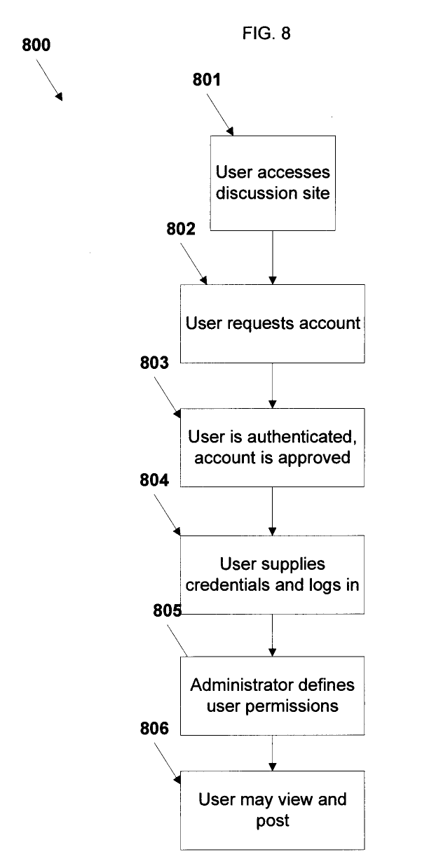

FIG. 8 illustrates an exemplary user registration process within the present system, according to one embodiment.

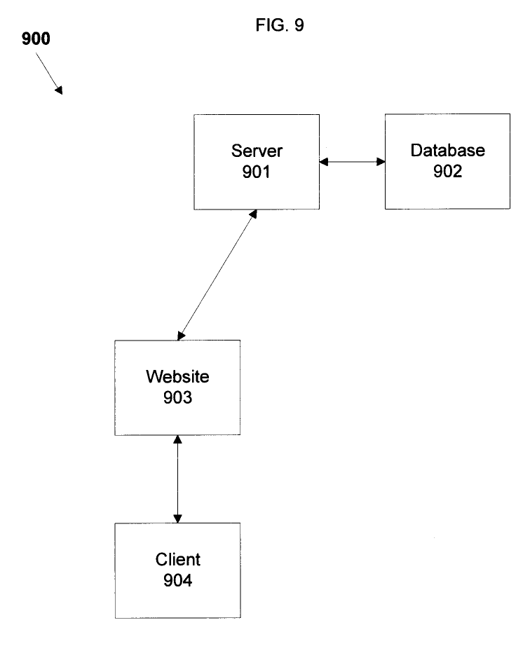

FIG. 9 is an exemplary system level diagram of the present system, according to one embodiment.

### DETAILED DESCRIPTION

A method and system for exchanging information regarding financial markets in a moderated environment are disclosed. According to one embodiment, a computer-implemented method comprises granting an administrator access to a collaborative interface, wherein the collaborative interface is one for a financial group that accepts posts from registered group members and distributes posts to the registered group members upon submission of new posts, and wherein the administrator approves the distribution of each new post. One or more clients are granted access to the collaborative interface, wherein the administrator identifies a permission level for each client. Posts are received from the administrator or a client of the one or more additional clients, approval is received from the administrator to display the post, and the post is displayed.

An exemplary financial services corporation is made up of financial advisors in communication with other financial advisors, clients and research analysts providing information to each other to communicate, generate ideas and exchange information. A compliance team, attorney or designee has the ability to review, modify, edit or delete all information that flows through the system.

The present system provides teams within a financial services corporation the ability to exchange information and electronically discuss the information in a moderated, collaborative environment. The present system provides the proper control and management over who can manage, modify, read or write the exchanged information and electronic discussions and who can run reports for compliance purposes.

According to one embodiment, the exchange of information regarding financial markets includes but is not limited to ideas, disseminating news, charts, links to outside stories, text, images, hyperlinks, and discussions between multiple users.

According to one embodiment, after registration with the system, users join topical discussion groups. Groups engage users in real-time discussion with one another. Groups and their topics are administered by a hosting (or sponsoring) organization's administrator. First time users choose a username which is associated with their account. The username is linked to the user's hosting organization data their name, email, and other necessary information is accessible by administrators and the identifying key is the user ID. All user content is retroactively credited to the current username associated with the user ID. For example, if user KWassong posts 5 times, then changes his username to KevinW, those original 5 posts will appear under the current username, KevinW, rather than the name under which they were posted, Kwassong. A malicious user is not able to hide their history by changing their username.

An exemplary interface includes script-enabled dynamic elements, swappable color schemes, and a user-tested layout and design. The application skin is configurable and can be modified to reflect a client's aesthetic theme. Script-enabled dynamic elements include the ability to jump to the most recent post or stay static, control the number of posts per page, control text sizes, turn alerts on and off, modify the display window size, display graphic images

According to one embodiment, users create and add posts to discussions in which they are participating. Posts are refreshed in real time. Posts are monitored for compliance, where possible. Monitoring includes language filters and the ability for users to report one another.

According to one embodiment, users can search posts. Search algorithms tokenize queries for reverse index lookup. Results are comprised of various data types, including articles, posts, and discussion groups.

According to one embodiment, and editorial administrator modifies and approves posts. An administrator can be an initial user who sets up a group. The administrator can prioritize posts in a queue and specify an interval period and date/time range for controlled auto-publishing. The administrator can also specify publish dates and times for individual posts. The administrator can rescind posts that have been published, and modify, suspend, or remove users and their accounts. Administrators can manage groups and their content, and have access to user and discussion group privileges and histories. The administrator can browse user posts and the posting history of a discussion group. Administrative pages and data are searchable for easy access to specific user accounts, groups, posts, or discussion groups.

According to one embodiment, users have varying levels of privileges and restrictions as set by an administrator.

According to one embodiment, administrator privileges include but are not limited to creating posts, editing posts, approving posts, accessing user accounts and chat history (including ability to edit, delete, and suspend), accessing discussion groups and chat history, and enabling or disabling moderators.

According to one embodiment, moderator privileges include but are not limited to editing and deleting user posts, and suspending users.

According to one embodiment, contributor privileges include but are not limited to creating and editing posts.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent process leading to a desired result. The process involves physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present method and system also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (“ROMs”), random access memories (“RAMs”), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the method and system as described herein.

FIG. 1 illustrates an exemplary computer architecture for use with the present system, according to one embodiment. One embodiment of architecture 100 comprises a system bus 120 for communicating information, and a processor 110 coupled to bus 120 for processing information. Architecture 100 further comprises a random access memory (RAM) or other dynamic storage device 125 (referred to herein as main memory), coupled to bus 120 for storing information and instructions to be executed by processor 110. Main memory 125 also may be used for storing temporary variables or other intermediate information during execution of instructions by processor 110. Architecture 100 also may include a read only memory (ROM) and/or other static storage device 126 coupled to bus 120 for storing static information and instructions used by processor 110.

A data storage device 127 such as a magnetic disk or optical disc and its corresponding drive may also be coupled to computer system 100 for storing information and instructions. Architecture 100 can also be coupled to a second I/O bus 150 via an I/O interface 130. A plurality of I/O devices may be coupled to I/O bus 150, including a display device 143, an input device (e.g., an alphanumeric input device 142 and/or a cursor control device 141).

The communication device 140 allows for access to other computers (servers or clients) via a network. The communication device 140 may comprise one or more modems, network interface cards, wireless network interfaces or other well known interface devices, such as those used for coupling to Ethernet, token ring, or other types of networks.

FIG. 2 illustrates exemplary actions available to a standard user as a reader within the present system, according to one embodiment. A standard user 201 may edit user preferences and option 202. Upon choosing to edit user preferences and option 202, specific groups and authors can be enabled or disabled 203 and standard options can be controlled 204. Standard options include but are not limited to application window size, typography, and viewing preferences. The standard user 201 can also view posts of host and sponsor writers 205. The user can also click on a search tab 206 and search for content within groups and posts 207.

FIG. 3 illustrates exemplary actions available to a standard user as a discussion participant within the present system, according to one embodiment. Similar to FIG. 2, a standard user 301 may edit user preferences and option 302. Upon choosing to edit user preferences and option 302, specific groups and authors can be enabled or disabled 303 and standard options can be controlled 304. Standard options include but are not limited to application window size, typography, and viewing preferences. The standard user 301 can also view posts of host and sponsor writers 305. The user can also click on a search tab 306 and search for content within groups and posts 307. Additionally as a discussion participant, the standard user 301 may view groups and select a topical group 308. The user may then participate by posting to the group discussion 309, and view posts added by other users 310.

FIG. 4 illustrates exemplary actions available to a user as an author within the present system, according to one embodiment. Similar to FIGS. 2 and 3, an author 401 may edit user preferences and option 402. Upon choosing to edit user preferences and options 402, specific groups and authors can be enabled or disabled 403 and standard options can be controlled 404. Standard options include but are not limited to application window size, typography, and viewing preferences. The author 401 can also view posts of host and sponsor writers 405. The author 401 can also click on a search tab 406 and search for content within groups and posts 407. Additionally as a discussion participant, the author 401 may view groups and select a topical group 408. The author 401 may then participate by posting to the group discussion 409, and view posts added by other users 410.

FIG. 5 illustrates exemplary actions available to a contributor within the present system, according to one embodiment. A contributor 501 can create a post 502 and modify a post 504. After creation or modification, the post is added to a queue 503, and once an administrator approves the post 505, the post is published 506.

FIG. 6 illustrates exemplary actions available to a moderator within the present system, according to one embodiment. A moderator 601 can maintain the environment and user generated discussions 602. The moderator may maintain an edit queue 603, warn, suspend, or ban users 604, and modify posts and suspend entire discussions 605.

FIG. 7 illustrates exemplary actions available to an administrator within the present system, according to one embodiment. An administrator 701 can moderate user content 702 and view use statistics 703. The administrator 701 also oversees the state of the environment 707. By overseeing the state of the environment 707, the administrator 701 can maintain an edit queue 704, manage and create group memberships, topics, content, and settings 705, and manage user accounts including memberships 706.

FIG. 8 illustrates an exemplary user registration process within the present system, according to one embodiment. A user registration process 800 includes a user accessing the discussion site 801 and requesting an account 802. The user is approved 803, and the user may supply the approved credentials to be authenticated 804. An administrator defines user permissions 805. Upon authentication the user may view and post 806.

FIG. 9 is an exemplary system level diagram of the present system, according to one embodiment. An exemplary system 900 includes a server 901 in communication with a database 902. The server 901 hosts a website 903, accessible by a client 904 (or multiple clients) over a network. The server 901 and client 904 systems have similar architectures to the exemplary architecture detailed in FIG. 1.

A method and system for exchanging information regarding financial markets in a moderated environment are disclosed. It is understood that the embodiments described herein are for the purpose of elucidation and should not be considered limiting the subject matter of the present embodiments. Various modifications, uses, substitutions, recombinations, improvements, methods of productions without departing from the scope or spirit of the present invention would be evident to a person skilled in the art.

We claim:

1. A computer-implemented method, comprising:
granting an administrator access to a collaborative interface, wherein the collaborative interface is one for a financial group that accepts posts from registered group members and distributes posts to the registered group members upon submission of new posts, and wherein the administrator approves the distribution of each new post;
granting one or more clients access to the collaborative interface, wherein the administrator identifies a permission level for each client;
receiving a post from the administrator or a client of the one or more additional clients;
receiving approval from the administrator to display the post; and
displaying the post.

2. The computer-implemented method of claim 1, further comprising the administrator
viewing posts;
creating posts;
editing posts;
accessing user accounts;
accessing user chat history;
accessing discussion groups; and
identifying a moderator.

3. The computer-implemented method of claim 1, further comprising a client of the one or more clients creating posts, editing posts and viewing posts.

4. The computer-implemented method of claim 2, further comprising a moderator
viewing posts;
creating posts;
editing posts; and
suspending a client.

5. The computer-implemented method of claim 1, wherein posts include one or more of application data files, hyperlinks, text, and images.

6. The computer-implemented method of claim 1, wherein the administrator accesses interface use statistics.

7. The computer-implemented method of claim 1, wherein the post is added to a queue before it is published.

8. A system, comprising:
a server hosting a website, the server in communication with a database; and
a collaborative interface residing on the website, wherein the server
grants an administrator access to a collaborative interface, wherein the collaborative interface is one for a financial group that accepts posts from registered group members and distributes posts to the registered group members upon submission of new posts, and wherein the administrator approves the distribution of each new post;
grants one or more clients access to the collaborative interface, wherein the administrator identifies a permission level for each client;
receives a post from the administrator or a client of the one or more additional clients;
receives approval from the administrator to display the post; and
displays the post.

9. The system of claim 8, further comprising the administrator
viewing posts;
creating posts;
editing posts;
accessing user accounts;
accessing user chat history;
accessing discussion groups; and
identifying a moderator.

10. The system of claim 8, further comprising a client of the one or more clients creating posts, editing posts and viewing posts.

11. The system of claim 9, further comprising a moderator
viewing posts;
creating posts;
editing posts; and
suspending a client.

12. The system of claim 8, wherein posts include one or more of application data files, hyperlinks, text, and images.

13. The system of claim 8, wherein the administrator accesses interface use statistics.

14. The system of claim 8, wherein the post is added to a queue before it is published.
